(19) United States
(12) Patent Application Publication
(10) Pub. No.: US 2026/0218390 A1
(43) Pub. Date: Jul. 30, 2026

(54) ELECTROLYSIS PROCESS FOR MAKING LITHIUM HYDROXIDE

(71) Applicant: Stellar Lithium LLC, Austin, TX (US)

(72) Inventors: Mukul M. Sharma, Austin, TX (US); Stoney Brett Barton, Austin, TX (US)

(21) Appl. No.: 19/313,246

(22) Filed: Aug. 28, 2025

Related U.S. Application Data
(63) Continuation of application No. 17/233,054, filed on Apr. 16, 2021, now abandoned.
(60) Provisional application No. 63/012,021, filed on Apr. 17, 2020.

(51) Int. Cl. C25B 1/20; C01D 15/02; C25B 1/04; C25B 1/16; C25B 1/26; C25B 1/34; C25B 9/23; C25B 11/075; C25B 13/02; C25C 1/02

(52) U.S. Cl. CPC C25B 1/20; C25B 1/04; C25B 1/16; C25B 1/26; C25B 1/34; C25B 9/23; C25B 11/075; C25B 13/02; C01D 15/02; C25C 1/02

(57) ABSTRACT

Systems and methods are described for producing lithium hydroxide from lithium chloride through an electrolysis process.

### PRIORITY CLAIM

This application is a continuation of U.S. patent application Ser. No. 17/233,054, filed Apr. 16, 2021, which claims the benefit of priority to U.S. Provisional Patent Application No. 63/012,021 to Sharma et al., entitled “ELECTROLYSIS PROCESS FOR MAKING LITHIUM HYDROXIDE”, filed Apr. 17, 2020, all of which are incorporated by reference in their entireties.

### BACKGROUND OF THE INVENTION

### 1. Field of the Invention

Embodiments described herein relate to systems and methods for producing lithium hydroxide. More particularly, embodiments described herein relate to a process to produce lithium hydroxide from lithium chloride through an electrolysis process.

### 2. Description of the Relevant Art

Lithium chloride is an industrial raw material that is typically used to make metallic lithium. Lithium hydroxide demand has increased steadily with its use as an electrolyte in storage batteries (e.g., lithium batteries). Currently, there are few processes that utilize lithium chloride to make lithium hydroxide. Some examples of current processes include processes described in U.S. Pat. Appl. Pub. No. 2019/0263669 to Malhotra, WIPO Publication No. 2018/158035 to Biglari, U.S. Pat. Appl. Pub. No. 2011/0044882 to Buckley et al., European Patent No. EP3061518 to Bertau et al., and European Patent No. EP1041177 to Guth et al., each of which is incorporated by reference as if fully set forth herein. The current processes may, however, be complex, expensive, and/or inefficient in producing lithium hydroxide from lithium chloride. Thus, there is a need for improvements in producing lithium hydroxide from lithium chloride using simple and efficient processing.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a representation of an embodiment of a system for producing lithium hydroxide from lithium chloride.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF THE PREFERRED EMBODIMENTS

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

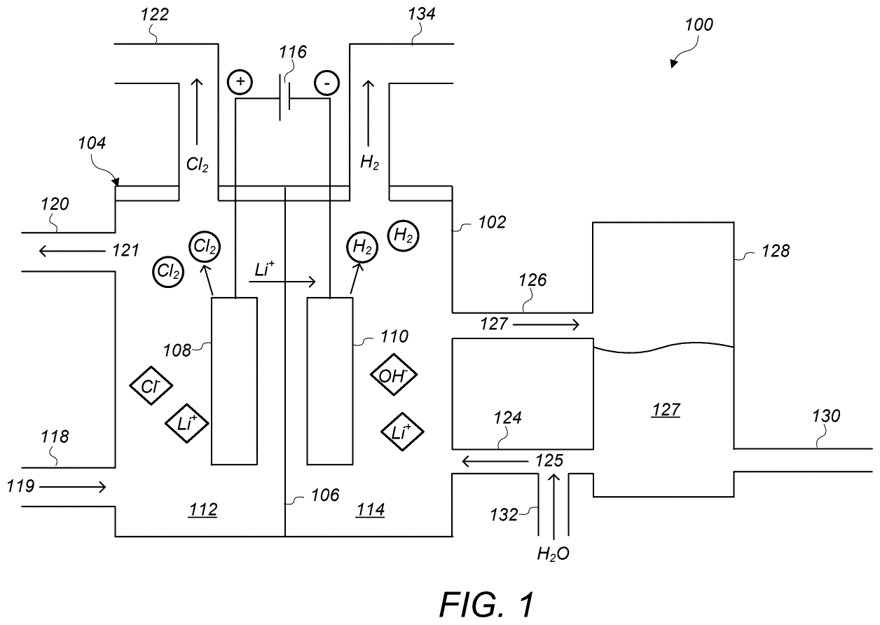

FIG. 1 depicts a representation of an embodiment of system 100 for producing lithium hydroxide from lithium chloride. In certain embodiments, system 100 is an electrolytic cell for producing lithium hydroxide from lithium chloride. In the illustrated embodiment, system 100 includes chamber 102. Chamber 102 may be, for example, an electrolysis reaction chamber or another reaction chamber. In some embodiments, chamber 102 includes lid 104. Lid 104 may be, for example, a top or other covering opened to provide access to the interior of chamber 102. For example, lid 104 may be removed to allow placement of electrodes and/or solution in chamber 102.

In various embodiments, chamber 102 includes membrane 106, anode 108, and cathode 110. Membrane 106 may be an ion-selective membrane. For example, membrane 106 may selectively allow lithium ions to pass through the membrane while inhibiting hydroxide ions and chloride ions from passing through the membrane. In various embodiments, membrane 106 has a selectivity for lithium ions that is comparable to the selectivity for sodium ions in a chloralkali process. In the illustrated embodiment, membrane 106 divides chamber 102 into first volume 112 and second volume 114 with anode 108 in the first volume and cathode 110 in the second volume. First volume 112 may thus be the anode side of membrane 106 while second volume 114 is the cathode side of the membrane.

In certain embodiments, a lithium chloride (LiCl) solution (e.g., a mixture of lithium chloride and water such as concentrated lithium chloride brine) is provided in first volume 112 to be in contact with anode 108 and a lithium hydroxide (LiOH) solution (e.g., a mixture of lithium hydroxide and water) is provided in second volume 114 to be in contact with cathode 110. Lithium ions (e.g., “Li⁺”) and chloride ions (e.g., “Cl⁻”) are formed from the lithium chloride solution in the first volume. Lithium ions are transported from first volume 112 to second volume 114 across membrane 106. In some contemplated embodiments, the loss of cations (e.g., lithium ions) may be made up for with application of an external current to anode 108 and cathode 110 from power supply 116.

In certain embodiments, a lithium chloride solution is circulated through first volume 112. For instance, inlet 118 and outlet 120 may be used to circulate lithium chloride solution through first volume 112. In some contemplated embodiments, inlet solution 119 may be concentrated lithium chloride brine while outlet solution 121 is depleted lithium chloride brine. Continuous circulation of the lithium chloride solution may inhibit the lithium chloride solution in first volume 112 from being depleted of lithium ions caused by transport of the lithium ions to second volume 114. As lithium ions are transported to second volume 114, chloride ions react at anode 108 to form chlorine gas according to the reaction: 2Cl⁻→Cl₂+2e⁻. Chlorine gas may be produced from first volume 112 through outlet 122.

In some embodiments, lithium hydroxide solution is circulated through second volume 114 (e.g., using inlet 124 and outlet 126 coupled to tank 128). As shown in FIG. 1, some of the lithium hydroxide solution in tank 128 may be produced through outlet 130 from system 100. In some embodiments, lithium hydroxide solution removed from tank 128 through outlet 130 may be produced by system 100 for use in production of lithium batteries. In some embodiments, water is added to the circulating lithium hydroxide solution entering second volume 114 using inlet 132. In such embodiments, inlet solution 125 is diluted compared to outlet solution 127, which is collected in tank 128.

In various embodiments, in second volume 114, lithium ions combine with hydroxide ions (e.g., “OH⁻”) generated from the reaction of water at cathode 110 and from hydroxide ions from lithium hydroxide in the lithium hydroxide solution. Hydroxide ions may be generated, for example, from water at cathode 110 according to the reaction: 2H₂O+2e⁻→H₂+2OH⁻. As hydroxide ions are consumed by the lithium ions, hydrogen gas may then be generated in second volume 114. Hydrogen gas may be produced from second volume 114 through outlet 134. In some embodiments, hydrogen gas produced from system 100 is used along with chlorine gas produced from the system to generate hydrochloric acid as a byproduct of the process that generates lithium hydroxide.

In various embodiments, the rate at which lithium hydroxide is formed in system 100 depends, at least in part, on the voltages being applied to anode 108 and cathode 110, the rate at which the ions are formed, the rate lithium ions are transported through membrane 106, the rate ions react with each other, or combinations thereof. Reactions between ions may occur either in solution or at the interface between the solution and the electrodes (e.g., anode 108 and cathode 110). Factors (e.g., component parameters) that may be considered in the process of making lithium hydroxide using system 100 include, but are not limited to:
The materials and/or construction of anode 108 and cathode 110;
Ion selectivity and ion transport properties of membrane 106; and
Voltage and current applied to anode 108 and cathode 110.

In various embodiments, as described above, continuous circulation of the lithium chloride solution in first volume 112 provides a consistent or constant source of lithium ions. Application of a selected voltage and/or current at anode 108 and cathode 110 may provide a primary driving force for lithium ions to migrate to the cathode across membrane 106. In some contemplated embodiments, the selected voltage at anode 108 and cathode 110 is between about 1 VDC and about 5 VDC, between about 2 VDC and about 4 VDC, or between about 2 VDC and about 3 VDC. In some contemplated embodiments, the selected current at anode 108 and cathode 110 is between about 3000 A and about 8000 A, between about 4000 A and about 7000 A, or between about 5000 A and about 6000 A.

Another driving force for the lithium ions to migrate may be the difference in the concentration of lithium ions on either side of membrane 106. For example, a difference in chemical potential of ions in first volume 112 and second volume 114 may drive lithium ions across membrane 106. Any charge imbalance that is caused by the preferential migration of lithium ions may be compensated for by the removal of electrons by an external power source (e.g., power provided by power supply 116 coupled to anode 108). Excess chloride ions may thereby convert to chlorine gas, as described above.

In certain embodiments, membrane 106 preferentially allows lithium ions to migrate through the membrane. The rate at which lithium ions migrate (e.g., transport) through membrane 106 may be determined by properties such as, but not limited to:
a) The size of the pores in the membrane;
b) The ion exchange capacity of the membrane (or the charge density on the membrane surface);
c) The voltage applied across the membrane; and
d) The difference in ion concentration on either side of the membrane.
   In certain embodiments, the properties of membrane 106 are adjusted to ensure that it preferentially excludes anions (e.g., chloride ions) and allows cations (e.g., lithium ions) to pass through. In some embodiments, the selectivity of membrane 106 to lithium ions relative to other cations (e.g., sodium ions) may be less important as lithium is not being separated from other cations in system 100. Membrane 106, however, may be designed to increase or maximize the flux of lithium ions while inhibiting chloride ions from passing through the membrane. Membrane 106 may also be made from robust materials and be resistant to corrosive fluids such as acids and bases.

In certain embodiments, the combination of lithium cations with the hydroxide anion is ensured by continuously providing second volume 114 (e.g., the cathode cell) with a high concentration of hydroxide anions. For instance, the concentration of lithium hydroxide in second volume 114 may be controlled to ensure that a sufficient number of hydroxide ions remain present in the second volume during processing, thereby being available to combine with excess lithium ions migrating across membrane 106. In some embodiments, circulating an aqueous solution of lithium hydroxide solution (e.g., using inlet 124 and outlet 126) ensures that a sufficient number of hydroxide ions is maintained in second volume 114. Electrons may be continuously provided at cathode 110 (e.g., by a current applied to the cathode) to dissociate water at the cathode such that hydroxide ions are continuously generated and electro-neutrality can be maintained in chamber 102. In some embodiments, the formation of lithium hydroxide may result in an excess of protons, which can recombine to form hydrogen gas.

As described herein, the formation of lithium hydroxide can occur in solution or at the interface between the solution and cathode 110 (where the hydroxide ions are being generated). In various embodiments, the kinetics of formation of lithium hydroxide may be accelerated by reducing any kinetic barriers to the formation of lithium hydroxide. For example, reducing kinetic barriers may be accomplished in two ways: (a) increasing the surface area of the cathode-solution interface; and (b) reducing the free energy barrier for the combination of the lithium ions with hydroxide ions.

The rate of formation of lithium hydroxide at the cathode-solution interface (e.g., the surface of the cathode) may be, in some embodiments, a function of the surface area of contact between the electrolyte (e.g., lithium hydroxide solution) and the cathode. In such embodiments, increasing the cathode surface area may thus increase the rate of formation of lithium hydroxide at the cathode-solution interface. In various embodiments, the surface area of an electrode (e.g., cathode 110) is increased by coating the electrode with colloidal particles (e.g., nano- or micro-particles) that have a very large surface area. The surface area of the electrode may also be increased by using compacted, nano-particulate electrode materials. The large surface area provided by such materials may increase (possibly significantly) the access of the lithium ions to hydroxide ions on the electrode surface, thus increasing the rate of formation of lithium hydroxide.

The electrochemical potential of a single electrode may be defined with reference to a standard electrode, which may be assigned a value of zero. For example, the electrode chosen as the zero may be the standard hydrogen electrode (SHE). The SHE consists of 1 atm of hydrogen gas bubbled through a 1 M HCl solution, usually at room temperature. Platinum, which is chemically inert, may be used as the electrode. The reduction half-reaction chosen as the reference may be described as:

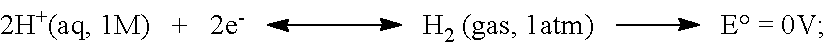

where E° is the standard reduction potential and the superscript “0” on the “E” denotes standard conditions (1 atm for gases, 1 M for solutes). The voltage is defined as zero for all temperatures.

The factors that determine the lithium ion discharging capacity through intercalation may include, but not be limited to: (1) the capability of the host, or the electrode, to change its valence states; (2) the available space to accommodate the lithium ions; and (3) the reversibility of the intercalation reactions. In lithium batteries, lithium ions are transported to and from the cathode during the charge/discharge process. This process of charging and discharging ions at the electrodes is referred to as the intercalation and de-intercalation of ions and can be dependent on the energy barrier for the transfer of electrons from the electrode to/from the ion. The process is controlled by the Fermi level in which the electrons reside. The Fermi energy level refers to the energy level where the probability of occupation by electrons is equal to 0.5. Electrons typically fill energy levels below the Fermi level and the energy levels above the Fermi level are unoccupied. During the discharge of a lithium ion battery, electrons flow from the anode, which is at a high Fermi energy level, to the cathode, which is at a low Fermi energy level. The transfer of electrons to the lithium ion during a discharge process is strongly dependent on the Fermi levels of the electrons in the electrode material. For example, the electronic configuration of electrons in a transition metal ion in the cathode is 3d4s. Losing or gaining electrons in the d-orbital corresponds to the oxidation or reduction of the transition metal. The localization or delocalization of electrons in the orbital structure controls the energy barrier for cation discharge at the cathode. Based on these properties, various embodiments of electrodes that contain transition metals may be contemplated.

Transition metals include 38 elements in groups 3 through 12 of the periodic table. A particular aspect of transition metals is that their valence electrons, or the electrons they use to combine with other elements, are present in more than one shell. Because of this, transition metals often exhibit several common oxidation states. Examples of transition metals used for making cathodes include, but are not limited to, iron, cobalt, and nickel. The combination of lithium with these transition metals provides a way to form electrodes that can charge and discharge lithium ions more efficiently. In lithium batteries, the difference in electrical potential between the anode (mA) and the cathode (mC) is termed as the working voltage, sometimes referred to as the open circuit voltage, VOC. This working voltage is also limited by the electrochemical window of the electrolyte, which is determined by the energy gap between the highest occupied molecular orbital (HOMO) and the lowest unoccupied molecular orbital (LUMO). In various embodiments of lithium ion batteries, the anode and cathode are selected such that the mA of the anode lies below the LUMO and the mC of the cathode is located above the HOMO. Otherwise, the electrolyte may be reduced on the anode or oxidized on the cathode to form a passivating solid electrolyte interphase film.

System 100, shown in FIG. 1, however, may operate unlike lithium ion batteries as the intercalation and de-intercalation of lithium with the electrodes is typically not desirable in embodiments described herein. Thus, electrodes for system 100 (e.g., anode 108 and/or cathode 110) may be designed differently than electrodes used in lithium batteries. For instance, in some embodiments of system 100, intercalation of the lithium on the electrode surface is inhibited. To inhibit intercalation, the electrodes may include inert electrode materials and/or materials that dissociate water to provide hydroxide ions for further reaction with lithium ions in solution or at the solution-electrode interface. Such inert materials may also be stable under various acidic and basic conditions that may occur in system 100. Examples of such materials include, but are not limited to, graphite, graphene, platinum and other inert materials. In certain embodiments, these materials may be in forms that have very large surface areas of contact with the solution.

In some embodiments, it may be desirable to conduct the reaction on the electrode surface and intercalate the lithium ions with the electrode material. In such embodiments, the electrodes may include transition metals. If the lithium hydroxide forms on the electrode surface, however, it may cause the electrode to become increasingly ineffective. Thus, the ability of the electrode to generate hydroxide ions in the solution can be diminished.

In certain embodiments, the production capacity of system 100 is determined by the amount of lithium ions that are transported through membrane 106 (e.g., the ion-selective membrane). The generation of hydroxide ions at cathode 100 may be a rate limiting step in the production of lithium hydroxide. The current and voltage applied to anode 108 and cathode 110 may be a particular design parameter that can be optimized for system 100. In some embodiments, lithium may be reversibly inserted into and extracted from the electrodes. In such embodiments, this intercalation may also be a rate determining step. The electrochemical potential may vary with the electrode materials, which in turn may be related to the arrangement of electrons in electronic orbitals. Additional information on electrode materials may be needed as there are very few experimental studies on measuring the electrochemical potentials of electrode materials for use in systems with the properties of system 100. In various embodiments, electrochemical potentials of electrode materials may be based on the electronic structure and atomistic potentials. For instance, the voltage and current needed to efficiently operate the electrochemical cell may be estimated and the electrode materials that are most suitable for cell are selected accordingly.

In certain embodiments, a pure lithium chloride (or as close to pure as possible) is fed into the electrolysis reaction chamber (e.g., chamber 102) to increase efficiency of system 100. Different sources of lithium chloride may be available and the lithium content of these sources can vary substantially. In some instances, the lithium chloride solution may contain divalent ions such as calcium and magnesium. These divalent ions must be removed from the lithium chloride solution before entering chamber 102. To remove the ions, different processes can be contemplated such as, the addition of other chemicals to induce precipitation of the divalent ions, the use of ion selective membranes, and the use of adsorption of these divalent ions by an ion exchange resin. Many different types of ion exchange resins and ion selective membranes are available for this process. The choice of the specific membrane or ion exchange resin may depend, for example, on the composition of the brine.

In certain embodiments, in addition to the purity of the inlet feed stream, the outlet feed stream may be treated. There are different ways of extracting the lithium hydroxide formed in chamber 102. In one contemplated embodiment, the lithium hydroxide from the solution exiting chamber 102 is crystalized by cooling the solution. The solid crystals may then be filtered and removed as a product stream and the filtered solution recirculated through chamber 102. The recirculation allows continuous operation of chamber 102 without interruption. Other contemplated embodiments for removing the lithium hydroxide may include chemical precipitation and adsorption or extraction with a solvent.

In various embodiments, any impurities present in the outlet stream can be split into a recirculation stream that is fed back into the chamber 102 (e.g., the electrolyzer) and another stream that can be treated to remove the impurities. The fraction of fluid that is removed to treat the impurities can be varied from 0% to 100% depending on the level of impurities present and other factors such as the flow rate. The treatment of the impurities can vary and include processes such as ion exchange, precipitation and redissolution.

### Example Testing of System 100

In tests conducted using system 100, the concentration of lithium hydroxide at the inlet and the outlet of the anode in chamber 102 were measured continuously by titration. Data for the average concentration of lithium hydroxide in the inlet and the outlet sides of the anode from these tests is provided below in TABLE I.

TABLE 1

| | | End of hour # | | | | | | | | | | |
|---|---|---|---|---|---|---|---|---|---|---|---|---|
| | | 1 | 2 | 3 | 4 | 5 | 6 | 7 | 8 | 9 | 10 | 11 |
| LiOH | Wt % | 7.90 | 7.86 | 7.72 | 7.78 | 7.85 | 7.89 | 7.79 | 7.79 | 7.88 | 7.98 | 8.26 |
| FEED | | | | | | | | | | | | |
| LiOH | Wt % | 10.42 | 10.51 | 10.34 | 10.34 | 10.23 | 10.15 | 10.20 | 10.25 | 102.5 | 10.09 | 10.12 |
| EXIT | | | | | | | | | | | | |

| | | End of hour # | | | | | | | | | | |
|---|---|---|---|---|---|---|---|---|---|---|---|---|
| | | 12 | 13 | 14 | 15 | 16 | 17 | 18 | 19 | 20 | 21 | 22 |
| LiOH | Wt % | 8.30 | | 8.32 | | 8.38 | 8.29 | 8.42 | 8.60 | 8.74 | 8.78 | 8.47 |
| FEED | | | | | | | | | | | | |
| LiOH | Wt % | 10.16 | | 10.13 | | 10.10 | 10.10 | 10.16 | 10.17 | 10.09 | 10.15 | 10.21 |
| EXIT | | | | | | | | | | | | |

| | | End of hour # | | | | | | | | | |
|---|---|---|---|---|---|---|---|---|---|---|---|
| | | 23 | 24 | 25 | 26 | 27 | 28 | 29 | 30 | 31 | 32 |
| LiOH | Wt % | 8.55 | 8.63 | 8.68 | 8.77 | 8.77 | 8.67 | 8.67 | 8.74 | 8.94 | 8.87 |
| FEED | | | | | | | | | | | |
| LiOH | Wt % | 10.21 | 10.32 | 10.31 | 10.39 | 10.38 | 10.37 | 10.37 | 10.42 | 10.48 | 10.47 |
| EXIT | | | | | | | | | | | |

As shown by the data in TABLE I, the concentration of the lithium hydroxide clearly increases as it passes through chamber 102. This increase is indicative of the formation of the lithium hydroxide on the anode side of chamber 102. If the concentration of the lithium hydroxide is kept at or near the saturation concentration of the lithium hydroxide, as was done in some of the tests, crystals of lithium hydroxide are observed as the effluent solution is cooled.

Additionally, tests were conducted under various conditions of temperature and inlet concentrations. In every test conducted, the concentration of lithium hydroxide on the anode side of chamber 102 was found to increase. The rate of formation of the lithium hydroxide varies as the temperature, voltage, and the current density are changed. The voltage and current density plots were also analyzed and were compared with theoretical estimates. Results indicated that the conversion efficiency of the lithium hydroxide was high.

Several variables in the tests were adjusted to test (and determine) conditions that may represent the optimum and most efficient operation of system 100. For example, the membrane in chamber 102 (e.g., membrane 106) was used in its sodium state as well as converted to the lithium state before the test was run. The electrodes were examined for any residue or contamination such that minor modifications could be made to the electrodes if needed. Embodiments may be contemplated in which some of the electrode modifications described herein are implemented to improve the efficiency of the process in system 100. The process, however, was shown to work under a wide range of conditions.

Results from the test of system 100 clearly indicate that the proposed method for generating lithium hydroxide described herein is efficient at generating lithium hydroxide from a lithium chloride solution.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

What is claimed is:

1. A method for making lithium hydroxide, comprising:
providing a mixture of lithium chloride and water to an electrolysis reaction chamber, wherein the electrolysis reaction chamber includes:
a first volume separated from a second volume by an ion-selective membrane, wherein the ion-selective membrane selectively allows lithium ions to pass through the membrane while inhibiting hydroxide ions and chloride ions from passing through the membrane;
an anode positioned in the first volume; and
a cathode positioned in the second volume;
wherein the mixture is provided to the first volume;
providing water or an aqueous solution of lithium hydroxide to the second volume;
providing a selected voltage to the anode and the cathode from a power supply,
producing chlorine gas from the first volume;
producing hydrogen gas from the second volume; and
producing a solution of lithium hydroxide from the second volume.

2. The method of claim 1, wherein the ion-selective membrane has a selectivity for lithium ions determined by at least one of the ion exchange capacity of the membrane, the degree of hydration of the membrane, or a pore size in the membrane.

3. The method of claim 1, wherein the ion-selective membrane has a selectivity for lithium ions that is comparable to the selectivity for sodium ions in a chloralkali process.

4. The method of claim 1, further comprising producing a diluted mixture of lithium chloride and water from the first volume, wherein the diluted mixture has a lower volume percentage of lithium chloride than the mixture provided to the first volume.

5. The method of claim 1, wherein the cathode has a coating of at least one of inert metal compounds or transition metal compounds.

6. The method of claim 5, wherein the coating is applied to the cathode as at least one of using nanoparticles, using a solution, or by electroplating.

7. The method of claim 1, wherein the anode has a coating of at least one of inert metal compounds or transition metal compounds.

8. The method of claim 7, wherein the coating is applied to the cathode as at least one of using nanoparticles, using a solution, or by electroplating.

9. The method of claim 1, further comprising pretreating the mixture to increase a percentage of lithium chloride in the mixture.

10. The method of claim 1, further comprising removing divalent ions from the mixture of lithium chloride and water before providing the mixture to the first volume.

11. The method of claim 1, further comprising cooling the produced solution of lithium hydroxide and filtering out crystallized lithium hydroxide from the cooled solution.

12. The method of claim 11, further comprising recirculating the cooled solution into the electrolysis reaction chamber after filtering out the crystallized lithium hydroxide.

13. A system for making lithium hydroxide, comprising:
an electrolysis reaction chamber, wherein the electrolysis reaction chamber includes:
an ion-selective membrane separating a first volume from a second volume in the chamber, wherein the ion-selective membrane selectively allows lithium ions to pass through the membrane while inhibiting hydroxide ions and chloride ions from passing through the membrane;
an anode positioned in the first volume; and
a cathode positioned in the second volume;
a mixture feed coupled to the first volume, wherein the mixture feed is configured to provide lithium chloride and water to the first volume;
a water feed coupled to the second volume;
a power supply coupled to the anode and the cathode, wherein the power supply is configured to provide a selected voltage to the anode and the cathode a first gas outlet coupled to the first volume, wherein the first gas outlet is configured to output chlorine gas from the first volume;
a second gas outlet coupled to the second volume, wherein the second gas outlet is configured to output hydrogen gas from the second volume; and
a first liquid outlet coupled to the first volume, wherein the first liquid outlet is configured to output lithium chloride and water with a lower volume percentage of lithium chloride than the mixture feed; and
a second liquid outlet coupled to the second volume, wherein the second liquid outlet is configured to output lithium hydroxide and water with a higher percentage of lithium hydroxide than the mixture feed from the second volume.

14. The system of claim 13, wherein the ion-selective membrane has a selectivity for lithium ions determined by at least one of the ion exchange capacity of the membrane, the degree of hydration of the membrane, or a pore size in the membrane.

15. The system of claim 13, wherein the ion-selective membrane has a selectivity for lithium ions that is comparable to the selectivity for sodium ions in a chloralkali process.

16. The system of claim 13, wherein the cathode has a coating of inert metal compounds or transition metal compounds.

17. The system of claim 16, wherein the coating includes nanoparticles of transition metal compounds or electroplated transition metal compounds.

18. The system of claim 13, wherein the anode has a coating of inert metal compounds or transition metal compounds.

19. The system of claim 18, wherein the coating includes nanoparticles of transition metal compounds or electroplated transition metal compounds.

20. The system of claim 13, further comprising a pretreating chamber coupled to the first volume, wherein the pretreating chamber is configured to increase a percentage of lithium chloride in the mixture feed before the mixture feed is provided to the first volume.
